(19) United States
(12) Patent Application Publication
(10) Pub. No.: US 2013/0060888 A1
(43) Pub. Date: Mar. 7, 2013

(54) COMMUNICATION DEVICE AND METHOD FOR RECEIVING MEDIA DATA

(71) Applicants: Kelvin Chee Mun Lee, Singapore (SG); Yeow Tong Tan, Singapore (SG); Robert Hsieh, Singapore (SG); Yidong Han, Singapore (SG)

(72) Inventors: Kelvin Chee Mun Lee, Singapore (SG); Yeow Tong Tan, Singapore (SG); Robert Hsieh, Singapore (SG); Yidong Han, Singapore (SG)

(73) Assignee: MP4SLS PTE LTD, Singapore (SG)

(21) Appl. No.: 13/325,786

(22) Filed: Dec. 14, 2011

Related U.S. Application Data
(63) Continuation of application No. 13/296,761, filed on Nov. 15, 2011.
(60) Provisional application No. 61/529,944, filed on Sep. 1, 2011.

(51) Int. Cl. G06F 15/16

(52) U.S. Cl. 709/217

(57) ABSTRACT

Communication devices are provided comprising a receiver configured to receive a data stream including data for reconstructing media data at a first quality level; a memory for storing data for reconstructing the media data at a second quality level wherein the first quality level is higher than the second quality level; a determiner configured to determine whether the reception rate of the data included in the data stream fulfills a predetermined criterion; and a processing circuit configured to reconstruct the media data from the data included in the data stream if it has been determined that the reception rate of the data included in the data stream fulfills the predetermined criterion and to reconstruct the media data from the data stored in the memory if it has been determined that the reception rate of the data included in the data stream does not fulfill the predetermined criterion.

### CROSS-REFERENCE TO RELATED APPLICATIONS

This application is a continuation of U.S. application Ser. No. 13/296,761, filed Nov. 15, 2011, which is a non-provisional of 61/529,944, filed Sep. 1, 2011, which is hereby incorporated herein in its entirety by reference.

### FIELD OF THE INVENTION

Embodiments of the invention generally relate to a communication device and a method for receiving media data.

### BACKGROUND OF THE INVENTION

Music is leading the creative industries into the digital revolution. In 2009, more than a quarter of the recorded music industry's global revenues (27%) came from digital channels—a market worth an estimated US$4.2 billion in trade value, up 12% on 2008. Consumers today can access and pay for music in diverse ways: they may buy tracks or albums from download stores, use subscription services or music services bundled with devices, buy mobile applications (“apps”) for music, or listen to music through streaming services for free.

It is typically desirable for a user to minimize the occurrences of pauses (or idle times) that the user experiences while listening to music streaming (or generally streaming media data such as audio data and video data) on a computing device such as a mobile communication device (like a smartphone) or a desktop device. Furthermore, it would be desirable that an uninterrupted playback experience for the user (i.e. streaming with a low or possibly no pauses) is possible both when the computing device is online and offline (e.g. is disconnected from the streaming server, e.g. is disconnected from the Internet, for a brief period of time during the streaming).

An approach is to monitor the network bandwidth available for the streaming and adapt the streaming rate based on the observed network conditions (i.e. the observed available bandwidth) and pre-buffer the stream as much as possible on-the-fly. This, however, does not address outage situations where the network suddenly become inaccessible due to for example, a poor wireless channel condition, a dropped network connection (e.g. due to overload of the base station or access point used) and/or switching or handover from one access network to another access network or from one base station to another base station by the computing device.

The document US2005/0175028A1 describes a method for improving the quality of playback in the packet-oriented transmission of audio/video data. According to the method described, multiple “logical streams” are delivered in one given logical channel bound by the available network bandwidth between a server device and a client device. The logical streams are made up of one base bit stream and a number of enhancement bit streams. The available network bandwidth adapts over time and causes fluctuation in the logical channel capacity. It should be noted that the available network bandwidth is also shared by other application in other logical channels. The available logical channel capacity then governs the decision of whether any enhancement bit stream should be sent and, if any, the number of enhancement bit streams that should be sent. The base bit stream is sent in a just-in-time manner. In this way, the quality of the streaming experience adapts to the logical channel capacity as enhancement bit streams are added (i.e. stitched on top of base bit stream) or removed.

This does not address offline playback and extended network outage situations. In essence, it can be seen to only consider intermittent network disconnectivity and streaming the content on-the-fly and in a just-in-time fashion. In case of network outage caused by the client device switching to another network, extremely poor wireless coverage or network overload, the continuous stream stops as soon as the playback buffer is emptied.

Other techniques for minimizing streaming playback pause experience can for example be broken down into the following categories:

1) Pre-buffering. A simple pre-buffering technique is to pre-buffer all the streamed content before playback of the content is started. This ensures uninterrupted playback. Another pre-buffering technique deals with buffering only content that is expected to be played back soon before the content is actually being played. This typically involves algorithms or heuristics for determining the likely-hood of a particular content portion being accessed in the near future to decide whether to pre-buffer the content portion. This approach, however, does typically not work well with resource deprived wireless networks as inaccurate selection of the content portions to pre-buffer results in wasting communication resources that could for example otherwise be used to deliver content.

2) Pre-bursting. The idea of pre-bursting can be seen in bursting the content to an edge server that is close to the client device to minimize the risk of disruption and delay in the streaming and to thus minimize the experience of pausing by the user. However, pre-bursting does not address network outage situations where the communication network used for the streaming suddenly become inaccessible for the client device.

3) Multi location buffering. The idea of multi location buffering can be seen in buffering the content in multiple “locations” in advance. This works as if multiple pre-buffering operations were carried out concurrently. A location can be considered as a unit or a portion of the content. Hence, the selected locations to buffer are typically around the vicinity of the content portion currently played back or possible future seeking positions in the content. This approach may address network outage issues better than pre-buffering. However, inaccurate selection of the portions to be buffered can be seen to multiply greatly the negative effect of consuming more resources in resource deprived wireless networks.

### SUMMARY OF THE INVENTION

In one embodiment, a communication device is provided including a receiver configured to receive a data stream including data for reconstructing media data at a first quality level; a memory for storing data for reconstructing the media data at a second quality level wherein the first quality level is higher than the second quality level; a determiner configured to determine whether the rate of reception of the data included in the data stream fulfills a predetermined criterion; and a processing circuit configured to reconstruct the media data from the data included in the data stream if it has been determined that the rate of reception of the data included in the data stream fulfills the predetermined criterion and to reconstruct the media data from the data stored in the memory if it has been determined that the rate of reception of the data included in the data stream does not fulfill the predetermined criterion.

According to another embodiment, a method for receiving data according to the communication device described above is provided.

### SHORT DESCRIPTION OF THE FIGURES

Illustrative embodiments of the invention are explained below with reference to the drawings.

FIG. 1 shows a communication device according to an embodiment.

FIG. 2 shows a flow diagram according to an embodiment.

FIG. 3 shows a communication arrangement according to an embodiment.

FIG. 4 shows a flow diagram according to an embodiment.

### DETAILED DESCRIPTION

According to one embodiment, the risk of the occurrence of a pause in a stream being played back by a client device is reduced. Further, according to one embodiment, offline playback is addressed such that pauses in stream playback may even be avoided in case of network outage (e.g. a period of disconnection of the client device from the communication network used for the streaming).

According to one embodiment, in contrast to providing offline playback by pre-caching the entire content in full but not in just-in-time basis (i.e. loading the content completely prior to playback), offline playback content is delivered in the same manner as a live stream. Hence, according to one embodiment, the content is on-demand, though it may be chosen to deliver it as-fast-as-possible or just-in-time.

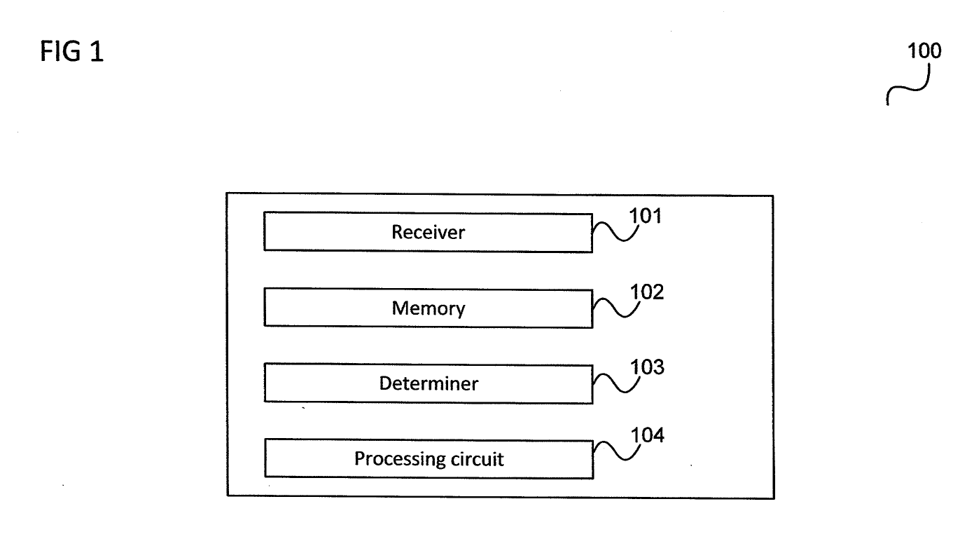

A client device according to one embodiment has for example the configuration as illustrated in FIG. 1.

FIG. 1 shows a communication device 100 according to an embodiment.

The communication device 100 includes a receiver 101 configured to receive a data stream including data for reconstructing media data at a first quality level.

The communication device 100 further includes a memory 102 for storing data for reconstructing the media data at a second quality level wherein the first quality level is higher than the second quality level.

Further, the communication device 100 includes a determiner 103 configured to determine whether the rate of reception of the data included in the data stream fulfills a predetermined criterion.

The communication device 100 further includes a processing circuit 104 configured to reconstruct the media data from the data included in the data stream if it has been determined that the rate of reception of the data included in the data stream fulfills the predetermined criterion and to reconstruct the media data from the data stored in the memory if it has been determined that the rate of reception of the data included in the data stream does not fulfill the predetermined criterion.

According to one embodiment, in other words, media data is reconstructed from a data stream in case this data stream fulfills a certain criterion, e.g. in case the playback of the media data can then be carried out at a certain quality level (e.g. without interruptions noticeable by the user), and otherwise, it is reconstructed from stored data which provides a lower encoding quality level (e.g. a lower media bit rate) than the data stream but which may otherwise avoid problems in the playback, e.g. may avoid interruptions in the playback.

The data for reconstructing the media data at the second quality level may for example be also be received by the receiver (e.g. by means of a further data stream) and be stored in the memory by the receiver. According to one embodiment, in other words, a reduction of the number of streaming pauses (i.e. interruptions in the playback of stream media data) is achieved by an approach that actually sends more data than necessary for the streaming in case of sufficient available network bandwidth to the client device. This may initially be seen to be counter intuitive, since the original design assumption of streaming can be seen to be based on the premises that, given a certain quality level of the streamed media data, a minimum amount of data (and therefore the shortest delivery time) should be sent to the client device to minimize the chance of hitting network outage (e.g. due to the required bandwidth exceeding the available bandwidth) during stream delivery. In other words, according to one embodiment, by sending slightly more data at the appropriate moment, there is a trade-off between this overhead and uninterrupted playback irrespective of whether the device is online or offline.

The data stream (also referred to as first data stream in the following) may be seen as a live stream and the further data stream that may be used to transmit the data for reconstructing the media data at a second quality level may be seen be seen as a cache data stream (also referred to as second data stream in the following). It should be noted that in various embodiments, the data for reconstructing the media data at a second quality level does not necessarily have to be streamed to the communication device like, in one embodiment, the data stream, but may have been transferred to the memory by any other means.

According to one embodiment, the data for reconstructing the media data at the first quality level is the media data encoded at the first quality level.

The data for reconstructing the media data at the second quality level is for example the media data encoded at the second quality level.

According to one embodiment, the communication device further includes a data stream memory configured to store received data of the data stream. The data stream memory is for example a buffer.

For example, the data stream memory is a buffer for pre-buffering the data stream.

According to one embodiment, the receiver is further configured to receive a further data stream including the data for reconstructing the media data at the second quality level and to store the data included in the further data stream in the memory.

According to one embodiment, the media data comprises media data for each frame of a plurality of frames and the receiver is configured to, for each frame, complete reception of the data for reconstructing the media data of the frame included in the further data stream earlier than the reception of the data for reconstructing the media data of the frame included in the data stream.

The criterion is for example that the reconstructed media data fulfills a predetermined playback quality criterion when the processing circuit reconstructs the media data from the data included in the data stream.

For example, the predetermined playback quality criterion is that the media data can be played back without interruptions due to re-buffering.

The communication device may further include a playback buffer configured to buffer the reconstructed media data.

The communication device may further include a playback device for outputting the reconstructed media data, wherein the playback buffer is configured to buffer the reconstructed media data for the playback device.

The criterion is for example that the rate of reception of the data included in the data stream is sufficient such that the buffer filling level of the playback buffer is above a predetermined threshold when the processing circuit reconstructs the media data from the data included in the data stream.

According to one embodiment, the determiner is configured to determine whether the criterion is fulfilled based on the buffer filling level of the playback buffer.

The media data for example includes media data for each frame of a plurality of frames and the data stream includes, for each frame, a higher amount of data for reconstructing the media data of the frame than the data stored in the memory.

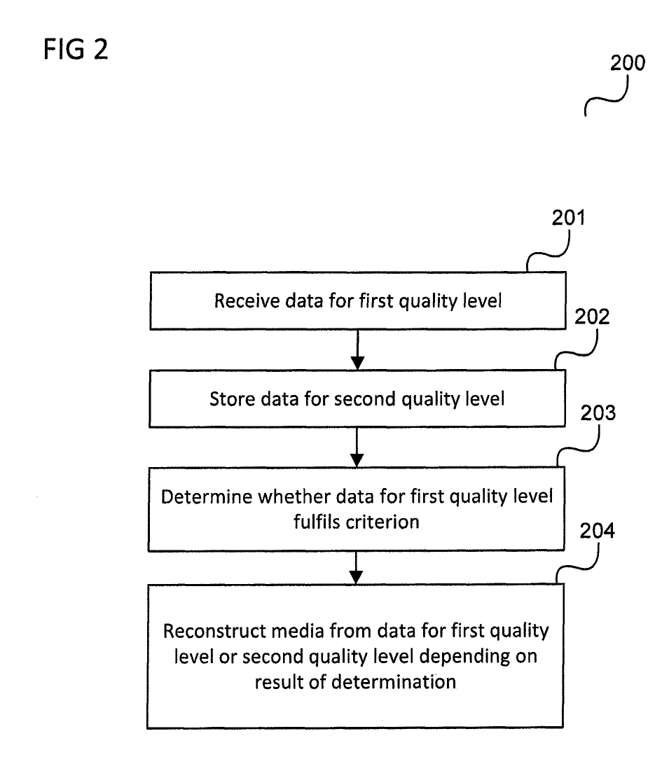

The communication device 100 for example carries out a method as illustrated in FIG. 2.

FIG. 2 shows a flow diagram 200 according to an embodiment.

In 201, a data stream is received including data for reconstructing media data at a first quality level.

In 202 (which may be carried out before, after or concurrently to 201), data for reconstructing the media data at a second quality level is stored wherein the first quality level is higher than the second quality level.

In 203, it is determined whether the rate of reception of the data included in the data stream fulfills a predetermined criterion.

In 204, the media data is reconstructed from the data included in the data stream if it has been determined that the rate of reception of the data included in the data stream fulfills the predetermined criterion and the media data is reconstructed from the data stored in the memory if it has been determined that the rate of reception of the data included in the data stream does not fulfill the predetermined criterion.

It should be noted that embodiments described in context with the communication device 100 shown in FIG. 1 are analogously valid for the method for receiving media data described with reference to FIG. 2 and vice versa.

In the following, embodiments are described in more detail.

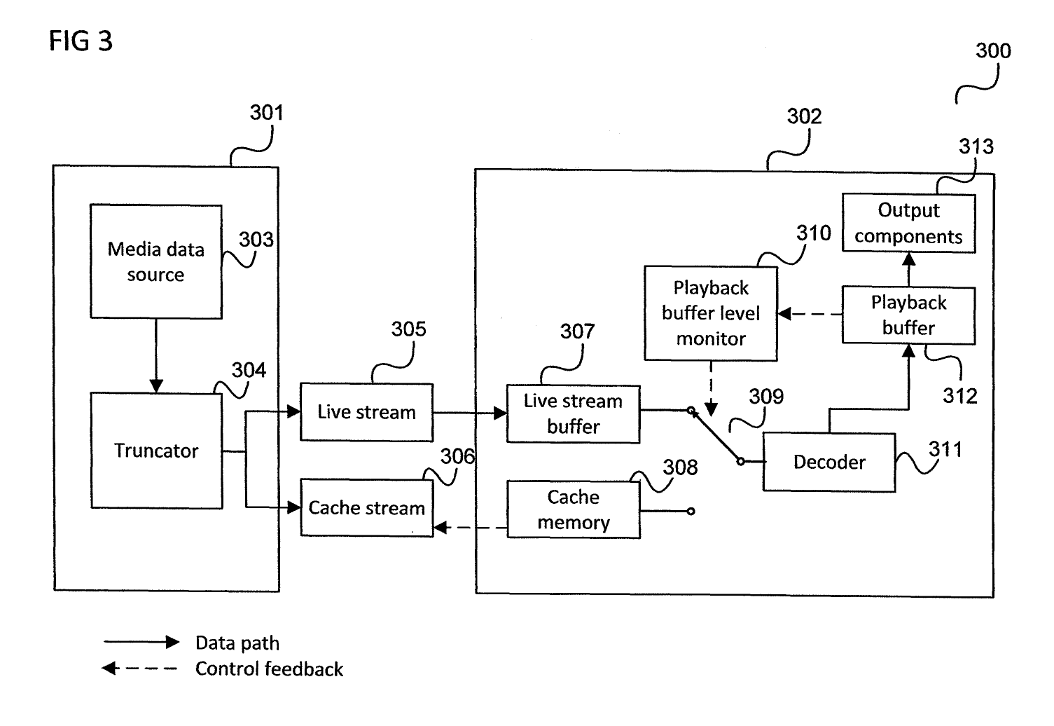

FIG. 3 shows a communication arrangement 300 according to an embodiment.

The communication arrangement 300 includes a server device 301 and a client device 302. The server device includes a source of scalable encoded audio (or generally media) data 303. For example, the server device has a memory of scalably encoded audio content or is connected to a database including such a memory (such that the source of scalable encoded audio data 303 could in this case be understood as an interface to this database).

The client device 302 for example requests the server device 303 to stream a certain audio content (e.g. a certain piece of music) to the client device 302. The server 301 then provides, by means of the source of scalable encoded audio data 303, a scalably encoded version of this audio content to a truncator 304 of the server device 301. The encoded audio content provided to the truncator 304 is for example scalably encoded according to MPEG-4 SLS (Scalable Lossless Coding).

One of the major merits of MPEG-4 SLS encoding can be seen in that the bit-stream generated from the encoder and forming the encoded audio content can be further truncated to lower data rates (and thus quality levels) easily by dropping bits at the end of each frame (i.e., for each frame, at the end of the bit stream including the encoded audio content for this frame).

The truncator uses this feature of the encoded audio content according to MPEG-4 SLS (or any other scalable encoding method used) to generate a first data stream 305 (live data stream) including the audio content at a first (higher) quality level and a second data stream 306 (cache data stream) including the audio content at a second (lower) quality level for on-demand delivery to the client device 302.

Thus, the cache stream 306 and the live stream 307 are generated from a single (e.g. lossless) audio source and the cache stream and the live stream bit rate, which can be fixed or dynamically changed, are set by truncating off the lossless source on-the-fly and, for example, on a per content basis.

The live data stream 305 and the cache data stream 406 are transmitted to the client device 302 by means of a communication network. For example, the client device is a mobile communication device (such as a smartphone) and is connected to the server device (which is for example a stationary computer) by means of a wireless communication network.

Thus, according to one embodiment, two independent and concurrent streams are transmitted to the client device 302. The cache stream 306 is encoded at a lower bit rate while the live stream is encoded at a higher bit rate. Each stream is for example transmitted by an individual logical channel. The two channels are bounded by the available bandwidth between the client device 302 and the server device 301. According to one embodiment, there is no explicit delivery prioritization between the two streams 306, 307. However, there may be an inherent or indirect prioritization by the network transport layer.

The cache stream 306 is for example a low bit rate stream and can be fixed at a constant rate on demand or can be adaptive based on a fixed ceiling and floor threshold rate on a per content basis. The cache stream 306 can be delivered to the client device 302 on a just-in-time basis, as-fast-as-possible or any permutation in between based on any rate adjustment algorithms and heuristics.

The live stream is for example a high bit rate stream and can be fixed at a constant rate on demand or can be adaptive based on a fixed ceiling and floor threshold rate on a per content basis. The live stream can be delivered on a just-in-time basis, as-fast-as-possible or any permutation in between based on any rate adjustment algorithm and heuristic. The client device 302 includes a live stream buffer 307 and a cache memory 308. The data received via the live data stream 305 is stored in the live stream buffer 307 and the data received via the cache data stream 306 is stored in the cache memory.

For example, the transmission of the cache stream 306 precedes the transmission of the live stream 305, i.e. data of the cache stream for a certain frame of the media content is (completely) transmitted (and received by the client device 302) before the data for the frame of the live stream 307. For example, in a boot strapping stage, the client device 302 connects to the server device 301 and the cache stream 306 is delivered to the client device 302. As soon as a portion of the cache stream is delivered to the client device 302 it is stored locally in the cache memory 308.

The client device 302 further includes a playback buffer level monitor 310, a decoder 311 and a playback buffer 312.

The decoder 311 reconstructs the audio content from encoded data supplied to it and supplies the reconstructed audio content to the playback buffer 312 (e.g. a playback buffer used by an audio playback application running on the client device 302). The playback buffer 312 forwards the reconstructed audio content to one or more output components 313 (such as a digital to analog converter and a loudspeaker or a headphone).

The playback buffer level monitor 310 is configured to monitor the buffer filling level of the playback buffer 312. The playback buffer level monitor 310 controls a switch 309 based on the buffer filling level of the playback buffer 312. According to the setting of the switch 309, either data stored the live stream buffer 307 or data stored in the cache memory 308 are forwarded to the decoder 311 for reconstructing the audio content.

For example, the client device 302 predominantly plays of the live stream 305 (i.e. reconstructs the audio content from the data stored in the live stream buffer) but it can switch to the cache stream 306 (i.e. switch to reconstructing the audio content from the data stored in the cache memory) as soon as the buffer level of the playback buffer 312 is below a preset minimum threshold. It should be noted that the buffer level of the playback buffer 312 is in this example different from the buffer level of the client device buffer level (which can be seen as the buffer level of the live stream buffer 307). The playback buffer 312 receives audio content either from the live stream streamed via the communication network or from the cache stream 306 which may be stored further in advance in the cache memory 308 (i.e. the client device's local storage).

The switching to the cache stream can be carried out with high speed since the retrieval of content from the cache memory 308 can be implemented as a local access within the client device 302. The retrieved data, indexed by frame number for instance, is aligned with the playback frame number at the time of the switching. After the switching, a content request to a future playback position may be made to the server device 301.

The playback buffer level monitor (e.g. a playback buffer switch and align module) switches from the cache memory 308 to the live stream buffer 307 once the playback buffer level, including future playback content, is sufficiently higher than the minimum threshold. A realign process then ensures that the switching back is smooth by aligning the buffered data frame number in the live stream buffer 307 to the playback frame number.

Once the realignment is done, the data from the live data stream is passed to the decoder 311 for processing before outputting to the playback buffer 312, which is e.g. part of a playback module (e.g. including at least some of the output components 313). The playback module may send an update about the current playback frame number to the playback buffer level monitor 310.

The cache memory 308 may manage the delivery of the cache stream 306 on a per content basis. If the current playback of an the live stream 305 including a certain content (e.g. a certain piece of music) is ongoing but the cache stream 306 has already been delivered for this content, the cache memory may decide to start caching the cache stream 306 of other content, e.g. based on a predefined content list.

The order of caching other content can be based on any algorithm or heuristic that minimizes the chance of playback interruption. For instance, if the user skips to a new content for which the associated cache stream has not yet been delivered to the client device 302, the cache memory may pause the transmission of a current cache stream (e.g. pause a current cache stream session) and request transmission of the cache stream associated with the new content to be delivered immediately.

The key rationale behind the approach of concurrently streaming the live stream 305 and the cache stream 306 from the server device 301 to the client device 302 can be seen in that if the channel capacity is sufficiently large to stream a live stream, then the cache stream should also be able to be delivered across the same available bandwidth at the expense of reduced channel capacity for the live stream.

Embodiments as for example described above allow uninterrupted online as well as offline playback.

According to various embodiments, the content scalability is not based on coarse discrete enhancement layers but rather on one single adaptive layer with much finer scalable steps. This means less complexity on the client device 302 and no enhancement layer stitching is required.

As described above, according to one embodiment, the cache stream 306 and the live stream 305 work off (i.e. are generated from) a single lossless original content (such as a single scalably encoded version of a piece of music). The bit rate of the streams 305, 306 can be determined on-the-fly and on a per content basis. Truncation is used to obtain the desired bit rate.

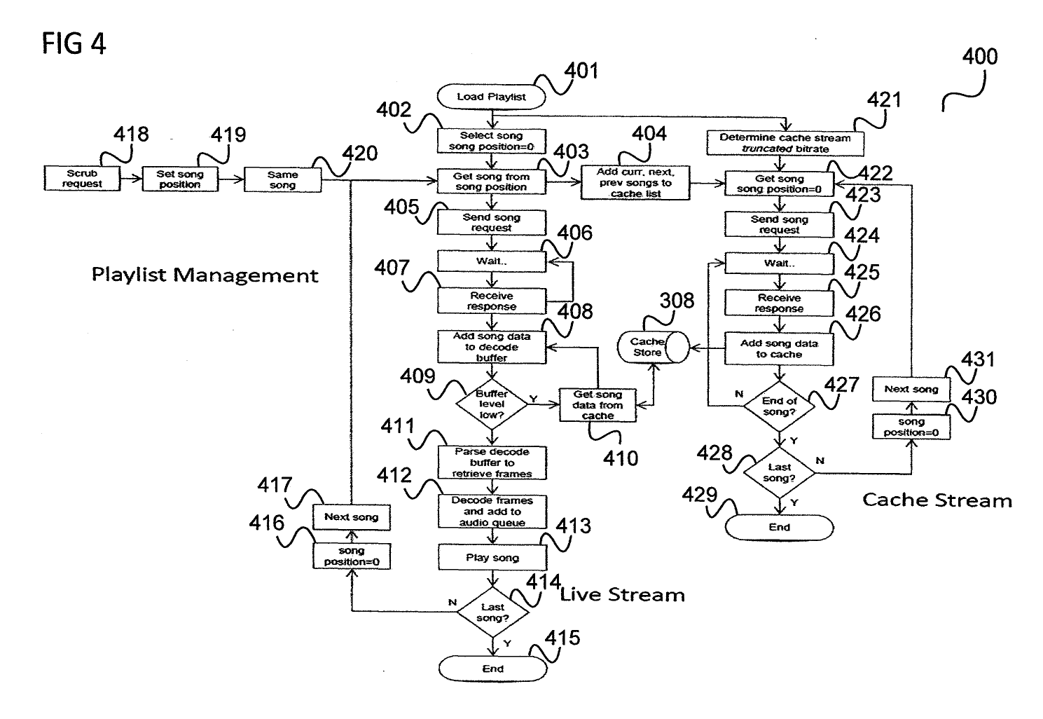

During content scrubbing/seeking, the client device 302 is able to switch immediately from the live stream to the cache stream and can therefore achieve uninterrupted playback. The client device 302 can switch back from the cache stream (i.e. from reconstructing the media content from cache stream data) to the live stream (i.e. from reconstructing the media content from live stream data) once the content of the newly seek position has arrived at the client device 302. An example of an operation of the communication arrangement 300 explained in the following with reference to FIG. 4.

FIG. 4 shows a flow diagram 400 according to an embodiment.

In 401, the client device 302 loads a playlist of songs.

In 402, the song position of the current song (starting with the first song from the playlist) is set to zero (beginning of song).

In 403, the client device initiates getting the song from the song position.

In 404, the current song, the next song (according to the playlist) and, if applicable, one or more previous songs of the play list are put onto a cache list.

In 405, the client device 302 sends a request for the current song to the server device 302.

In 406, the client device 302 waits for a response from the server device 301.

In 407, the client device 302 receives the response from the server device 301 (if there is no response yet, it continues to wait).

In 408, after having received the response, the client device 302 puts the song data received in the response (i.e. the live data stream) into the input buffer of the decoder 311.

In 409, if the buffer level of the input buffer of the decoder 311 is low, the client device 302 starts to get song data from the cache memory 308 in 410 and puts these song data into the input buffer of the decoder 311 in 408.

It should be noted that in this example, in contrast to what was explained in context of FIG. 3 above, the decision on whether to supply data from the live data stream of the cache data stream to the decoder is based on the level of the input buffer of the decoder 311 while according to what was described above with reference to FIG. 3, the decision is based on the level of the playback buffer 312. Both variants may be used according to various embodiments. According to one embodiment, the decision may for example also be based on the filling level of the live stream buffer 307.

In 411, the decoder 311 parses the contents of its input buffer to retrieve the encoded frame data.

In 412, the frame data is decoded and put into the audio output queue (i.e., e.g., the playback buffer 312).

In 413, the current song is played.

If, in 414, the last song of the playlist has been played, the process is ended in 415.

Otherwise, the song position is again set to zero in 416 and the next song in the play list is set as the current song in 417 and the process continues with 403.

In case of a scrubbing (seeking) request in 418 (e.g. input by the user), the song position is set according to the scrubbing request in 419. The current song is kept as the current song in 420 and the process continues with 403.

For providing the cached song data, i.e. the data stored in the cache memory 308, the bit rate of the cache stream 306 is determined in 421. In 422, the song position is set to zero and in 423, the client device 423 sends a request for the cache stream for the current song on the cache list (starting with the first song on the cache list) to the server device 301.

In 424, the client device 302 waits for a response from the server device 301, i.e. for the cache stream for the current song on the cache list. In 425, the client device receives the cache stream and adds the received song data into the cache memory 308 in 426. This reception process is continued until the end of the song has been reached in 427.

If, in 428, the current song on the cache list is the last song on the cache list, the process is stopped in 429. If the current song on the cache list is not the last song on the cache list, the song position is set to zero in 430, the current song on the cache list is set to the next song on the cache list and the process is continued with 422.

The streaming of media content according to various embodiments as described above may for example be used in context of a digital long-playing app (DLP) as described in the following.

In this context, it should be noted that the music industry is diversifying its business models and revenue streams. It is beginning to embrace new business models and gadgets for delivering music to consumers. Recent innovations include the introduction of digital album downloads and on-demand music streaming, driven in part by the proliferation of smart-phone devices. Moreover, the forms of content which may be delivered through these devices, in the form of apps, are rapidly increasing. Today, with music record labels set to deliver music to a greater range of devices in a greater variety of formats, the digital music industry is poised to exploit the enormous popularity of mobile devices and apps.

With these developments, some artists have begun to explore the interactive, visual and social possibilities of new technologies. Specifically, they are discovering how apps for mobile devices can offer a higher quality of music entertainment experience for listeners. For example, music albums may be released as apps including audio content in CD-quality (in “lossless” audio format) and for example further including lyrics and essays for songs, as well as exclusive interactive content, video extras and access to a forum where fans can interact with the artist through text and live web chats.

However, the “album in an app” product suffers a fundamental drawback. The drawback is that the size of the app is very large, e.g. about 450 MB. Lossless quality audio files are inherently large, averaging 30-35 MB per track. With an album consisting of 10 or more tracks, the size of the app becomes too large for the consumer purchase experience to be simple, seamless and instantly gratifying. Therefore, many potential consumers will simply not purchase these music album apps. Moreover, given the size of these apps, many will be restricted to a small number of music album app purchases because of the lack of storage capacity in mobile devices.

This issue cannot be addressed by reducing the size of the app without compromising the audio fidelity quality of the tracks.

According to one embodiment, this is addressed by streaming the tracks of a music album instead of storing them within the app wherein it is avoided that audio fidelity playback quality is adversely affected due to access network outrages or congestion disrupting the real-time streaming process.

According to one embodiment, a digital music product is used with lightweight digital footprint of no more than 300-400 Kb because it does not store an album's audio tracks within the app. The music tracks may be for example transmitted as described above with reference to FIG. 3 through a combination of a hi-fidelity audio live stream (e.g. from a network adaptive audio streaming server that adapts the music streaming rate based on observed network conditions) and a cache-audio stream which may be transmitted concurrently with the live stream (e.g. preceding the live stream by a number of frames or even tracks) or may be pre-stored in the app on the client device.

Thus, a user is able to store a large quantity of music album apps in a mobile device (e.g. a smartphone or a tablet computer) as the digital footprints are miniscule (compared with current music album apps including the music content). Hi-fidelity audio playback is available immediately upon purchase as music listeners do not need to wait for long periods of time for the lightweight app to download.

According to one embodiment, such an app is called a digital long-playing app (DLP) for the following reasons:

a) Digital—it is a digital music album and delivery system

b) Long-Playing—it is akin to the long-playing record; it offers a program including of a limited number of music (playlist) tracks in high-fidelity (up to lossless) CD-quality audio and associated digital works

c) App—it is a software app accessible through major app store platforms

The DLP can be seen as a digital music app that allows playing back music albums tracks in hi-fidelity streaming audio quality on mobile smart-phone and tablet computer platforms anytime on-demand. It can analogously be applied to other digital works including music, music videos, artwork, audio, sound, multi-media, pictures, short films, movies, video clips, television programs, audio books, talks, speeches, voice content, lectures, software and any type of digital works.

Although the DLP can be seen to share some features with digital album downloads and digital on-demand audio streaming services, the DLP can have, according to various embodiment, the following distinguishing attributes. They may for example include the following:

a) No downloading of music content required—Unlike digital albums which are downloaded onto a user's computing device, the digital album of a DLP is streamed to the user;

b) No perpetual subscription required—Unlike on-demand digital streaming music services which are primarily accessible only by continual monthly subscription payments, the digital album of a DLP can be made permanently accessible once purchased by paying a one-time payment. It is a single-purchase transaction.

c) Unprecedented quality-of-entertainment experience—Unlike on-demand music streaming services and the majority of digital album downloads, the DLP offers hi-fidelity, scalable to lossless audio quality to music listeners. Using the online and offline scalable audio playback delivery method described above with reference to FIGS. 1 to 3, the DLP can be made to feature hi-fidelity, scalable lossless audio quality music playback (whenever connected to the delivery network) and uninterrupted, continuous music playback whenever it the client device is offline or when network connectivity is not available or severely hampered by network congestion and outage situations.

Consequently, the DLP can be seen to function as a digital, long-playing record album application. Furthermore, according to various embodiments, it does so at a standard of quality of service and entertainment experience similar to that of analogue long-playing records and digital music compact discs, surpassing quality of service levels associated with the current state-of-art in music album apps.

According to an embodiment, the main features of a DLP are as follows:

a) Lightweight—the digital footprint is about 300-400 Kb

b) Audio sampling rate—44.1 KHz/16 Bit; up to 192 KHz/24 Bit

c) Number of program tracks—Ten to twenty (10-20 tracks per LP)

d)Audio playback fidelity quality—Up to 1,411 kbps lossless audio fidelity (live stream); up to 128 kbps bit rate quality (offline cache); higher if higher audio sample rate adopted

e) Listening time—Between 40-80 minutes

f) Audio coding format—Fine-granularity scalable lossless format, such as, MPEG-4 SLS

g) Delivery method—Scalable lossless fidelity audio streaming over IP, dedicated content delivery, cellular networks

h) Playback—Software app player on smart-phones and tablet computer platforms and PC web-browser player on MAC/WINDOWS/LINUX operating systems

According to one embodiment, a digital long playing app (also referred to as LP program) is provided according to the following four stages:

### 1) LP Program Production

The original sound of the LP program tracks is recorded, mixed and transcribed in creating the Master Tape. Ideally, the Master Tape is in digital format (although analogue is acceptable as it can be converted to digital).

### 2) LP Preparation

The digital lossless reproduction of the Master Tape (in uncompressed lossless form), including security watermarks and metadata information, is encoded into single-source, fine-granularity scalable (FGS) audio format, such as MPEG-4 SLS, audio tracks and stored onto FGS content storage servers. The LP program tracks and metadata information (if recorded separately from the FGS file) are identified by a unique URL locator address on the server in IP and content distribution networks.

### 3) LP Distribution

The LP program is for example distributed as explained above with reference to FIGS. 1 to 3. Accordingly, according to one embodiment, the LP program is distributed by network adaptive streaming servers that take the FGS audio track of the LP to truncate to two (2) bit streams for delivery over IP and cellular networks. One bit stream is a high fidelity bit-rate live-stream (live stream) which is delivered to the live stream buffer located at the client DLP player (i.e. the client device). The live stream adapts dynamically to the access network connectivity bandwidth at the DLP player. If, for example, 800 kbps connectivity bandwidth is available, the server truncates the single-source FGS audio track to stream the live stream at the maximum available bandwidth, say 780-790 kbps bit-rate audio fidelity quality.

The other stream is a lower fidelity bit-rate stream (cache stream) which is delivered to the cache memory at the DLP player. The (server) delivery of the cache stream is continuous and independent of the live stream. The bit-rate audio quality level of the cache stream may be fixed or may be adjustable by the DLP player (client device). However, it is possible that the maximum bit-rate of the cache stream be limited to an intermediate audio quality level, such as, 96 kbps or 128 kbps bit-rate so as to reduce the length of time taken to deliver all of the LP program tracks into the cache memory.

### 4) LP Consumption (Playback)

LP playback begins when the first of the two truncated bit streams from the streaming server arrive at the DLP player. Should the low fidelity bit-rate streams arrive first, the DLP player decodes the bit-streams (from the cache memory) to playback. However, once the live stream arrives at the DLP player, the player switches from the cache memory to the live stream buffer playback. This switch, executed within an audio data frame ( 1/75 sec), is virtually instantaneous.

The operation of the playback switch between the cache memory and the live stream buffer is managed by the playback buffer switch and align (PBSA) module in the DLP player. The PBSA module monitors the real-time playback buffer status and switches audio bit-streams from cache memory to live stream buffer when the playback buffer level is above a preset minimum threshold level. The PBSA also uses the audio data frames numbering index to track that playback switching takes places when the audio data frames from the cache memory and live stream buffer are exactly aligned. When the buffer audio data frame is aligned to that of the live stream, playback switching will be smooth and free of real-time audio effects.

Conversely, when the playback buffer level is below a minimum threshold, the PBSA module switches playback from the live stream buffer to cache memory. Once again, the buffer and live stream audio data frames are tracked and correctly aligned when switching is executed. After the playback switch, a new request may be made by the DLP player to the streaming server to deliver a new live stream whose data frames are ahead of the frame position (track location) at the time of switch.

In both of the aforementioned conditions, once switching is established, the playback audio stream is sent to the decoder module for processing and output to the playback module of the DLP. The playback module then updates the real-time playback frame number (position) at the PBSA module.

The cache memory manages the delivery of the cache stream on a per audio track basis. If real-time playback from an existing live stream is ongoing and the cache stream of the playback track has been fully delivered, the cache memory may request the cache stream of another LP track to be delivered to the cache memory. Such a cache stream request may be based on a predefined ordering of the LP program tracks or based on any algorithm or heuristics that optimizes the DLP performance, such as minimizing the instances of playback interruption due to the absence of audio data in cache memory. For example, when the user skips to an LP track whose cache stream has not yet been delivered to the DLP, the cache memory may stop the current cache stream session and request the cache stream associated with the LP track to be delivered immediately.

1. A communication device comprising:
a receiver configured to receive a first data stream including data for reconstructing media data at a first quality level and configured to receive a second data stream including data for reconstructing the media data at a second quality level
wherein the first data stream comprises audio content truncated at a first truncation level and the second data stream comprises the encoded audio content truncated at a second truncation level such that the first quality level is higher than the second quality level and,
wherein the receiver receives both the first data stream and the second data stream from the same server device;
a memory for storing the data for reconstructing the media data at the second quality level;
a determiner configured to determine whether the rate of reception of the data included in the first data stream fulfills a predetermined criterion; and
a processing circuit configured to reconstruct the media data from the data included in the first data stream if it has been determined that the rate of reception of the data included in the first data stream fulfills the predetermined criterion and to reconstruct the media data from the data stored in the memory if it has been determined that the rate of reception of the data included in the first data stream does not fulfill the predetermined criterion.

2. The communication device according to claim 1, wherein the data for reconstructing the media data at the first quality level is the media data encoded at the first quality level.

3. The communication device according to claim 1, wherein the data for reconstructing the media data at the second quality level is the media data encoded at the second quality level.

4. The communication device according to claim 1, further including a data stream memory configured to store received data of the first data stream.

5. The communication device according to claim 4, wherein the data stream memory is a buffer.

6. The communication device according to claim 5, wherein the data stream memory is a buffer for pre-buffering the first data stream.

7. (canceled)

8. The communication device according to claim 1, wherein the media data comprises media data for each frame of a plurality of frames and wherein the receiver is configured to, for each frame, complete reception of the data for reconstructing the media data of the frame included in the second data stream earlier than the reception of the data for reconstructing the media data of the frame included in the first data stream.

9. The communication device according to claim 1, wherein the criterion is that the reconstructed media data fulfills a predetermined playback quality criterion when the processing circuit reconstructs the media data from the data included in the first data stream.

10. The communication device according to claim 9, wherein the predetermined playback quality criterion is that the media data can be played back without interruptions due to re-buffering.

11. The communication device according to claim 1, further comprising a playback buffer configured to buffer the reconstructed media data.

12. The communication device according to claim 11, further comprising a playback device for outputting the reconstructed media data, wherein the playback buffer is configured to buffer the reconstructed media data for the playback device.

13. The communication device according to claim 11, wherein the criterion is that the rate of reception of the data included in the first data stream is sufficient such that the buffer filling level of the playback buffer is above a predetermined threshold when the processing circuit reconstructs the media data from the data included in the first data stream.

14. The communication device according to claim 11, wherein the determiner is configured to determine whether the criterion is fulfilled based on the buffer filling level of the playback buffer.

15. The communication device according to claim 1, wherein the media data comprises media data for each frame of a plurality of frames and the first data stream includes, for each frame, a higher amount of data for reconstructing the media data of the frame than the data stored in the memory.

16. A method for receiving media data comprising:
receiving a first data stream including data for reconstructing media data at a first quality level and receiving a second data stream including data for reconstructing the media data at a second quality level
wherein the first data stream comprises audio content truncated at a first truncation level and the second data stream comprises the encoded audio content truncated at a second truncation level such that the first quality level is higher than the second quality level and,
wherein both the first data stream and the second data stream are received from the same server device;
storing the data for reconstructing the media data at the second quality level;
determining whether the rate of reception of the data included in the first data stream fulfills a predetermined criterion; and
reconstructing the media data from the data included in the first data stream if it has been determined that the rate of reception of the data included in the first data stream fulfills the predetermined criterion and to reconstruct the media data from the data stored in the memory if it has been determined that the rate of reception of the data included in the first data stream does not fulfill the predetermined criterion.
